(19) United States
(12) Patent Application Publication
(10) Pub. No.: US 2005/0267837 A1
(43) Pub. Date: Dec. 1, 2005

(54) Methods and systems for managing financial loan products using co-signor arrangements

(76) Inventor: Robert D. White, Midlothian, VA (US)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 10/854,683

(22) Filed: May 27, 2004

(51) Int. Cl. G06F 17/60

(52) U.S. Cl. 705/38

(57) ABSTRACT

Systems and methods are disclosed for managing financial loan products. The systems and methods may manage a financial loan product for a principal monetary amount and associated with a borrower, a co-signor, and an item of property, where the co-signor has a liability associated with the financial loan product. The system and method may receive payment data concerning payments made by the borrower towards the principal amount, and monitor a principal-to-value factor reflecting a currently owed amount of principal based on the received payment data and reflecting a market value of the item of property. The system and method may then determine, based on the monitored principal-to-value factor, whether to update the liability of the co-signor.

### FIELD OF THE INVENTION

The present invention generally relates to methods and systems for managing financial loan products, and, more particularly for financial loan products using co-signor arrangements.

### BACKGROUND OF THE INVENTION

Buying property, such as a new home, is often the largest purchase an individual will ever make. To buy a home, a buyer typically makes a down payment for a portion of the purchase price (e.g., 20%) and obtains financing for the remaining portion of the purchase price (e.g., the remaining 80%). The financial institution that finances the property purchase often requires the buyer's down payment to be a minimum amount. For example, most mortgage lenders require a down payment of at least 20% of the purchase price. Buyers with sufficiently high credit ratings may then obtain additional financing to cover a portion of the required down payment. This may then allow the buyer to obtain financing for up to, for instance, 95% of the purchase price. However, buyers making a smaller down payment are generally required to obtain a mortgage insurance policy to provide the lender with an additional level of protection. But paying for mortgage insurance is expensive and the buyer usually still needs to make a down payment, such as 5%.

First-time buyers often have the most difficulty financing a property purchase. For example, they may not have an established credit history and therefore, may not qualify for financing for more than 80% of the purchase price. They may also have difficulties obtaining funds for a down payment amount. And even if the buyer is able to come up with the required down payment and able to obtain financing for the remaining portion of the purchase price, the buyer is still likely to encounter burdensome financing requirements. For instance, such financing arrangements often include an onerous application process and burden buyers with writing multiple checks per month to each lender.

Accordingly, there is a need for a mortgage product that allows buyers to purchase property with low down-payments but without burdensome financing requirements.

### SUMMARY OF THE INVENTION

Consistent with embodiments of the present invention, systems and methods are disclosed for providing financial loan arrangements for an item of property.

In accordance with one embodiment, a method, performed by a processor, for managing a financial loan product is provided, where the financial loan product may be for a principal monetary amount and may be associated with a borrower, a co-signor, and an item of property. The co-signor may have a liability associated with the financial loan product. The method may comprise: receiving payment data concerning payments made by the borrower towards the principal amount; monitoring a principal-to-value factor reflecting a currently owed amount of principal based on the received payment data and reflecting a market value of the item of property; and determining, based on the monitored principal-to-value factor, whether to update the liability of the co-signor.

According to another embodiment, a system for managing a financial loan product is provided, where the financial loan product may be for a principal monetary amount and may be associated with a borrower, a co-signor, and an item of property. The co-signor may have a liability associated with the financial loan product. The system may comprise: a component for receiving payment data concerning payments made by the borrower towards the principal amount; a component for monitoring a principal-to-value factor reflecting a currently owed amount of principal based on the received payment data and reflecting a market value of the item of property; and a component for determining, based on the monitored principal-to-value factor, whether to update the liability of the co-signor.

In accordance with yet another embodiment, a computer-readable medium comprises a set of instructions which when executed perform a method for managing a financial loan product, where the financial loan product may be for a principal monetary amount and may be associated with a borrower, a co-signor, and an item of property. The co-signor may have a liability associated with the financial loan product. The method executed by the set of instructions may comprise: receiving payment data concerning payments made by the borrower towards the principal amount; monitoring a principal-to-value factor reflecting a currently owed amount of principal based on the received payment data and reflecting a market value of the item of property; and determining, based on the monitored principal-to-value factor, whether to update the liability of the co-signor.

It is to be understood that both the foregoing general description and the following detailed description are exemplary and explanatory only, and should not be considered restrictive of the scope of the invention, as described and claimed. Further, features and/or variations may be provided in addition to those set forth herein. For example, embodiments of the invention may be directed to various combinations and sub-combinations of the features described in the detailed description.

### BRIEF DESCRIPTION OF THE DRAWINGS

The accompanying drawings, which are incorporated in and constitute a part of this disclosure, illustrate various embodiments and aspects of the present invention. In the drawings:

FIG. 1 is a block diagram of an exemplary mortgage management system consistent with an embodiment of the present invention;

FIG. 2 is a flow chart of an exemplary method for managing a mortgage product, consistent with an embodiment of the present invention; and

FIG. 3 is a flow chart of an exemplary subroutine that may be used in the exemplary method of FIG. 2 for updating a co-signor's liability under a mortgage product, consistent with an embodiment of the present invention.

### DETAILED DESCRIPTION

The following detailed description refers to the accompanying drawings. Wherever possible, the same reference numbers are used in the drawings and the following description when referring to the same or similar parts. While several exemplary embodiments and features of the invention are described herein, modifications, adaptations, and other implementations are possible, without departing from the spirit and scope of the invention. For example, substitutions, additions, or modifications may be made to the components illustrated in the drawings, and the exemplary methods described herein may be modified by substituting, reordering, or adding steps to the disclosed methods. Accordingly, the following detailed description does not limit the invention. Instead, the proper scope of the invention is defined by the appended claims.

Systems and methods consistent with the present invention provide financing arrangements for property to borrowers. According to embodiments of the invention, a mortgage management system is provided for offering mortgage products in which the borrower has a co-signor. As used herein, the terms “mortgage” and “mortgage product” broadly refer to any type of financial loan arrangement for an item of property, whether the financing arrangement is commonly referred to as a mortgage or otherwise. The purchased property may also be any type of property, such as personal or real property, including, for example, land (whether vacant or developed), an ownership share in an existing building (e.g., a condominium), automobiles, or boats. In addition, the borrower and co-signor may be any type of entity, such as an individual, a group of individuals, a business, or a corporation. Further, as used herein, the term “co-signor” broadly refers to any entity that, along with the borrower, is jointly or partially liable for at least some portion of the loan amount financed via the mortgage product. The co-signor may assume liability for the financed loan amount by co-signing the mortgage along with the borrower.

By using the borrower and co-signor financing arrangements described herein, mortgage products consistent with the invention may minimize or even eliminate any required down payment from the borrower. In other words, the mortgage product may not require any down payment and may even offer financing for more than the purchase price. Once the borrower and co-signor have entered into the mortgage product, mortgage management systems consistent with the invention may then track or monitor payments made under the mortgage product and/or the value of the subject property.

To this end, the mortgage management system may determine a principal-to-value factor or “P/V factor” associated with a mortgage product. As used herein, the term “P/V factor” broadly refers to any factor, ratio, or value reflecting the current amount of principal owed under the mortgage product as compared to a market value associated with the subject item of property. For example, the P/V factor may indicate the percentage of the property's market value that corresponds to the currently owed amount of principal. As the amount owed and the property's market value changes, the system may monitor the P/V factor to determine whether to update the co-signor's liability. For instance, the system may extinguish the co-signor's liability when the P/V ratio reaches a predetermined threshold value. As part of determining whether to update the co-signor's liability, the system may also notify the borrower and/or co-signor that the co-signor's liability may be updated or possibly extinguished, as well as the requirements for such updating of the co-signor's liability. If the co-signor's liability is extinguished, the borrower may then remain solely liable for the loan amount financed via the mortgage product.

An embodiment consistent with the invention may comprise a system for managing a financial loan product is provided, where the financial loan product may be for a principal monetary amount and may be associated with a borrower, a co-signor, and an item of property, and where the co-signor may have a liability associated with the financial loan product. The system may comprise: a component for receiving payment data concerning payments made by the borrower towards the principal amount; a component for monitoring a principal-to-value factor reflecting a currently owed amount of principal based on the received payment data and reflecting a market value of the item of property; and a component for determining, based on the monitored principal-to-value factor, whether to update the liability of the co-signor.

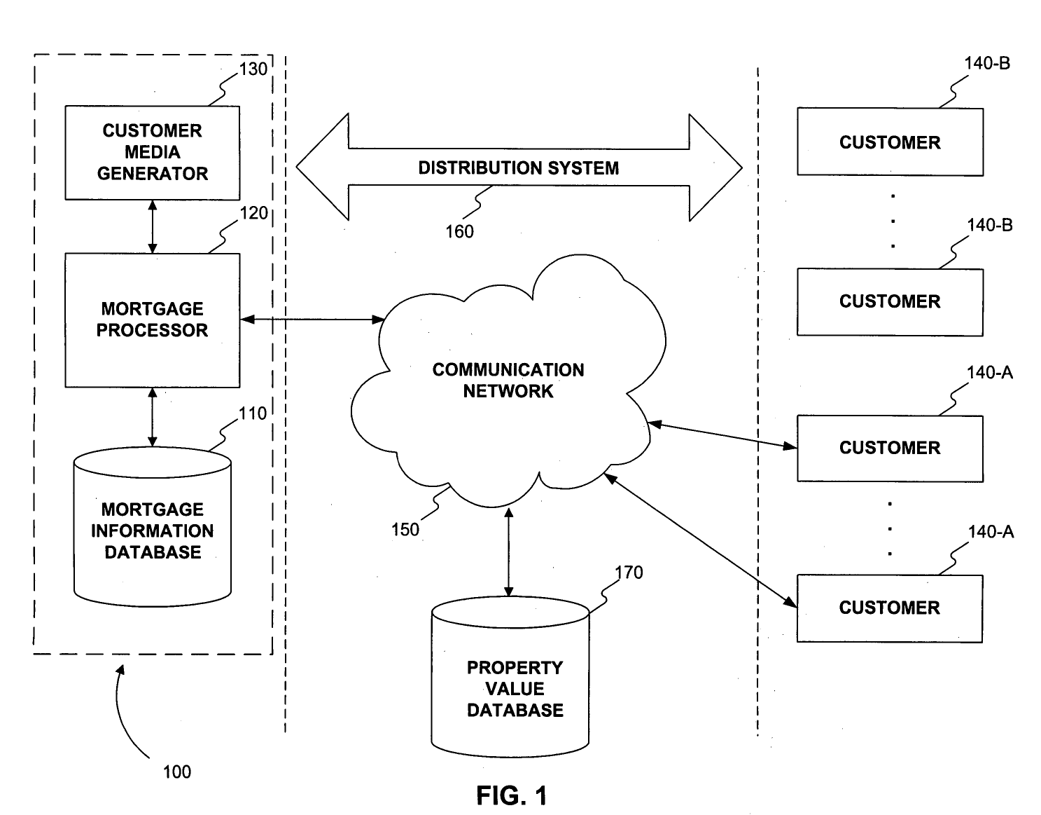

Consistent with an embodiment of the present invention, the aforementioned components may be implemented in a mortgage management system, such as an exemplary mortgage management system 100 of FIG. 1. Any suitable combination of hardware, software, and/or firmware may be used to implement the management system 100. Further, system 100 is exemplary and other systems may comprise the aforementioned mortgage management system, consistent with embodiments of the present invention.

By way of a non-limiting example, FIG. 1 illustrates an exemplary environment for implementing embodiments of system 100 consistent with the present invention. As shown in FIG. 1, the exemplary system environment includes a number of components, including a mortgage information database 110, a mortgage processor 120, and a customer media generator 130. These components may be included within mortgage management system 100 and may be owned or operated by an entity that offers and/or manages mortgage products and/or services to customers. These customers may include customers 140-A who have access to a communication network 150, as well as other customers 140-B who do not have, or elect to use, network access, but who may have access to distribution network 160. Customers 140 may, for example, be borrowers and co-signors associated with offered mortgage products. As further disclosed herein, communication network 150 and distribution network 160 may permit system 100 to communicate with customers 140 with respect to mortgage products managed by system 100. Further, as shown in FIG. 1, system 100 may also communicate with a property value database 170 for obtaining information on market values for properties associated with mortgage products managed by system 100.

Database 110, processor 120 and customer media generator 130 may be implemented through any suitable combination of hardware, software and/or firmware. Such components may be directly or indirectly connected with one another, or provided as part of an integrated system. By way of non-limiting examples, the disclosed components may be implemented using one or more general-purpose computer(s), mainframe(s), or computing platform(s) selectively activated or reconfigured by program code to provide the necessary functionality. Further, one or more of these components may be outsourced to or operated by a third party that provides, for example, hosted database, applications and/or other services.

Mortgage information database 110 may store any information or logic needed for implementing embodiments of the invention. For example, database 110 may store mortgage product and/or service information offered by an entity. Database 110 may also include customer information related to borrowers for property loans, co-signors, mortgage products, and information and/or logic for monitoring mortgage products, such as a respective P/V factor. For instance, database 110 may store data on a currently owed amount of principal for a loan amount, payments made by a borrower towards the principal loan amount, a market value for subject property, as well as other information about the borrower, the co-signor, and the subject property.

Consistent with an embodiment of the invention, database 110 may be implemented by various memory or storage devices, such as a high-density memory or storage device. Such a storage device may be implemented to provide persistent storage of data, and may be organized as a relational database. Further, database 110 may be directly connected or integrated with processor 120, or it may be indirectly connected using, for example, a local area network (not shown). Also, while a single database is illustrated in FIG. 1, it is possible to distribute data residing in database 110 over various databases or storage devices.

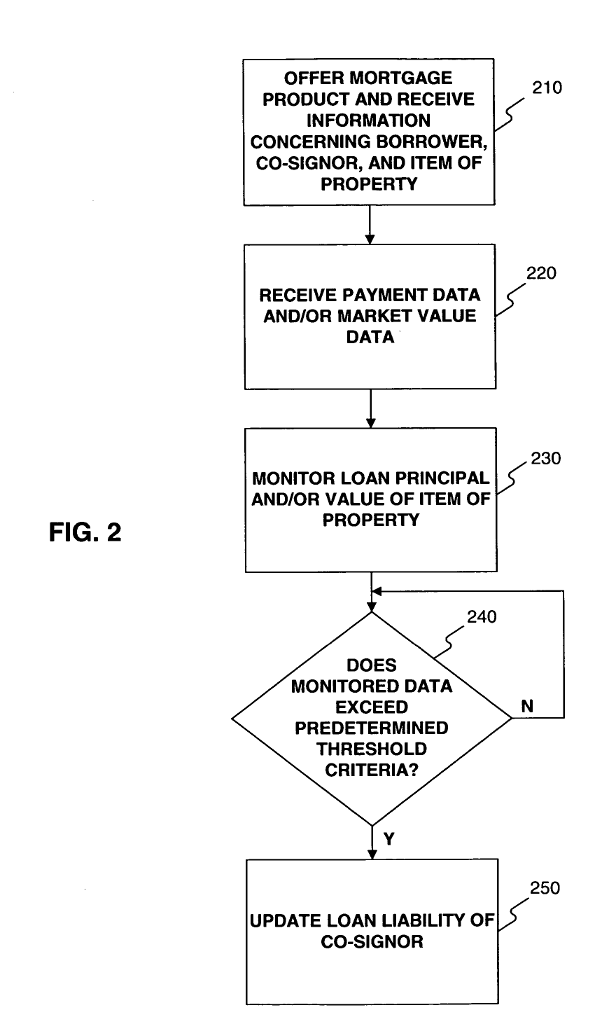

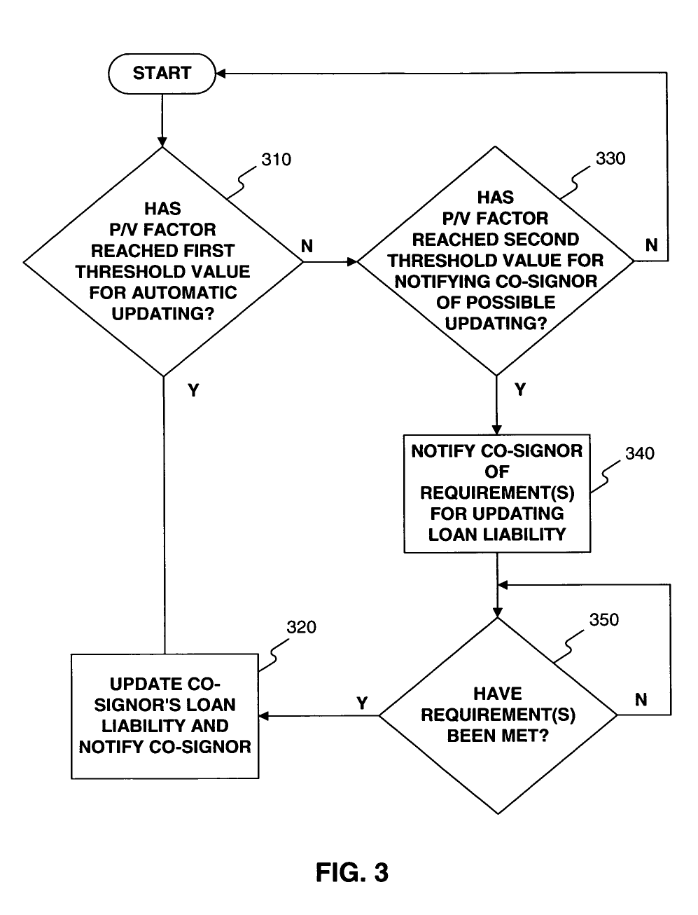

Processor 120 incorporates functionality for performing methods related to embodiments of the invention. Such functionality may be provided through software and/or hardware configuration(s) residing in processor 120. Additionally, or alternatively, processor 120 may execute software residing in a memory device, (e.g., database 110) to perform one or more processes consistent with embodiments related to the present invention. As further disclosed herein, processor 120 may be adapted to perform various functions including: analyzing payment data; analyzing market values of respective properties; monitoring L/V ratios associated with each mortgage product; generating media communications for distribution to customers; analyzing customer responses; and/or other functions. Further, processor 120 may be implemented to perform the functions described in detail below with respect to FIGS. 2 and 3.

To facilitate communication with customers, processor 120 may be adapted to communicate via network 150. Communication network 150 may comprise a network or combination of networks to permit communication between customers 140-A and processor 120. By way of non-limiting example, network 150 may comprise public or private networks, such as the Internet or a private intranet, and such a network or combination of networks may comprise wired and/or wireless networks. In addition, processor 120 may host or be connected to a separate server that hosts a Web site or set of Web pages that can be accessed by customers. In another embodiment, processor 120 may comprise or be connected to an e-mail server for receiving or sending electronic communications from or to customers via network 150.

Customer media generator 130 is combined to generate communication media for distribution to customers. Consistent with an embodiment of the invention, media generator 130 may be an internal system or generator of the entity for communicating with borrowers and co-signors about their associated mortgage products. Alternatively, some or all of the functions performed by media generator 130 may be outsourced to a third party entity. In such embodiments, the third party may generate and distribute communication media to customers. Further, the third party entity may provide communication media to system 100 for distribution to customers 140.

As further illustrated in FIG. 1, a distribution system 160 may be provided. Distribution system 160 may be used to distribute communication media generated by media generator 130 to customers 140. In one embodiment, distribution system 160 comprises a public or conventional mail system such as that provided by the U.S. Postal Service for mailing communication media to customers. In another embodiment, distribution system 160 includes a courier system or a private delivery system for sending the communication media to customers. The above are exemplary, however, and distribution system 160 may include other distribution channels.

Further, as also shown in FIG. 1, system 100 may communicate with a property value database 170. Database 170 may contain information on current market values for properties associated with mortgage products managed by system 100. System 100 may thus access database 170 via network 150 (or via distribution network 160, not shown) to obtain a current market value of a property for determining, for example, the P/V factor for that property. In one exemplary embodiment, database 170 comprises a governmental real estate tax database indicating currently assessed property values. Database 170 may, however, be implemented using other types of databases containing information on property market values, such as sales information available from a realtor or automobile resale value databases. In certain embodiment, database 170 may be implemented in system 100.

FIG. 2 illustrates an exemplary method consistent with the present invention for managing a mortgage product. As shown in FIG. 2, the exemplary method may begin at stage 210 where mortgage management system 100 offers mortgage products to borrowers. As described above, the mortgage product may be any type of financial loan arrangement for an item of property. For example, the mortgage product may be for financing the purchase of an item of property or refinancing a currently owned item of property. The mortgage product may also be for any type of loan, such as a traditional mortgage or an installment loan, and may be for any type of item of property, such as real or personal property. Further, system 100 may offer the mortgage products in any of a number of known ways for offering such products to customers, such as offering the mortgage product electronically over network 150 or via regular postal channels through distribution network 160.

As described above, mortgage products offered by system 100 may require the borrower to obtain a co-signor. The borrower and the co-signor may each be signatories to the mortgage product and may each be jointly or partially liable for at least some portion of the financed loan amount. Upon the borrower and co-signor purchasing, accepting, or otherwise entering into an agreement for a mortgage product, mortgage management system 100 may then receive information concerning the borrower, co-signor, and the item of property. For example, the received information may identify borrower and co-signor, such as their respective names, addresses, and other pertinent financial or identification information associated with them. The received information may also identify the item of property. For instance, if the item of property is real property, such as a parcel of land or a building, the received information may identify the location of the property, the extent of any development on the property, and associated governmental records for the property (e.g., real estate property tax records on the property, personal property tax records on the property, ownership records, etc.).

The exemplary method may then proceed to stage 220, where system 100 may receive payment data and/or market value data associated with the item of property. The payment data may be one or more payments made by the borrower (or the co-signor, in some cases) towards the loan, including payments toward principal and payments for interest charged by the financial entity that offers the mortgage product. System 100 may also receive market value data associated with the item of property from, for example, property value database 170 or from an appraisal sent to system 100 by a borrower or co-signor. In this respect, system 100 may either request such information to be sent to it or collect such information from, for example, database 170. Market value data may also be received as part of stage 210 where system 100 may receive information about the property, such as a property market value included in an appraisal done when the mortgage product was first entered into by the borrower.

The exemplary method may then proceed to stage 230, where mortgage processor 120 may determine and monitor a P/V factor associated with the property. The P/V factor may be based on the received payment data and/or the received market value data. For instance, the P/V factor may reflect the currently owed amount of principal and a market value for the property. In one exemplary embodiment, the P/V factor may indicate the percentage of the property's market value that corresponds to the currently owed amount of principal. To illustrate, if the market value of the property is $100,000 and the amount of principal owed by the borrower is $75,000, then the P/V factor is 0.75. The P/V factor thus changes as the amount of principal owed changes as well as when the market value of the property changes. The P/V factor may, however, be implemented using other ways to monitor the principal amount owed and a market value of the item of property.

Further, the market value used to determine the P/V factor is not limited to the current market value of the item of property. For instance, the P/V factor may reflect a market value (e.g., a purchase price) provided to system 100 when the borrower first enters into the mortgage product. Alternatively, processor 120 could obtain a current market value of the item of property as it determines and monitors the P/V factor. In these cases, system 100 may receive current market values from, for example, a property value database 170 or from a recent appraisal performed by the borrower, the co-signor, or an entity that may manage system 100.

As part of stage 240 of the exemplary method, mortgage processor 120 determines whether the monitored P/V factor satisfies predetermined threshold criteria. This threshold criteria may indicate when the liability of the co-signor associated with the mortgage product should be updated, such as extinguished. For instance, the predetermined threshold criteria may indicate a particular P/V factor that must be satisfied before extinguishing the co-signor's liability. In exemplary embodiments, the threshold criteria may reflect a P/V factor at which the financial entity offering the mortgage product would be willing to offer the mortgage product to the borrower without a co-signor. As an illustration, assume a borrower is required to make a down-payment of 20% of a property's purchase price in order to qualify for a mortgage product without a co-signor. The borrower, however, instead makes no down payment and uses a co-signor arrangement. The threshold criteria for this illustration may then require a P/V factor of 80% before extinguishing the co-signor's liability under the mortgage product.

If mortgage processor 120 determines at stage 240 that the predetermined threshold criteria has been met (i.e., “yes” at stage 240), then processing may proceed to stage 250 where processor 120 may update the co-signor's liability. Otherwise, processing may return to stage 230 where processor 120 continues to monitor the P/V factor to determine if the threshold criteria has been satisfied (i.e., “no” at stage 240). Further, as part of stage 250, system 100 may update the co-signor's liability by reducing the co-signor's liability, such as reducing one co-signor's liability by a determined percentage.

Further, the cosigner's liability may be continuously updated. For example, consider when the mortgage product is for a $180,000 loan on a $200,000 house, where the borrower makes a $20,000 down payment and a co-signor guarantees $20,000. After the borrower has made some loan payments, the loan principal may be $178,000. Payments made to the principal may be first applied to the amount associated with the co-signor's liability. Thus, in this example, the co-signer may only be liable for $18,000. Once the loan principal reaches $160,000, the co-signer's liability will be zero. The co-signer's liability may thus be updated with each payment made towards the loan.

As described, embodiments of the present invention enable processor 120 to monitor a P/V factor associated with a mortgage product, and adjust co-signors liability based on the monitoring. Methods and systems consistent with embodiments of the present invention may allow processor 120 to perform those processes using different techniques and/or components.

FIG. 3 is a flow chart of an exemplary subroutine that may be used in the exemplary method of FIG. 2 for implementing stages 240 and 250, consistent with an embodiment of the present invention. As shown in FIG. 3, at stage 310, mortgage processor 120 may determine whether the P/V factor is above a first threshold value for automatically updating the co-signor's liability under the mortgage product.

The first threshold value may indicate when the currently owed amount of principal is less than a certain proportion of a market value of the property. For instance, the first threshold value may correspond to a condition reflecting when the amount of principal owed by the borrower is equal to or less than a proportion of the property's market value. As an illustration, the first threshold value may correspond to the situation where the amount of principal owed is 80% of a market value of the property. This value may, for example, correspond to the P/V factor at which the financial entity offering the mortgage product would not require the borrower to obtain a co-signor for the loan. Further, if the current market value of one item of property is not available to mortgage processor 120 (e.g., only the market value at the time the borrower entered into the mortgage product is known), then the first threshold value may require a lower amount of owed principal to warrant automatically updating of the co-signor's liability without obtaining a current market value of the property. For example, the first threshold value may correspond to the amount of principal owed as being 60% of the known market value of the item of property.

When mortgage processor 120 determines that the first threshold has been reached, it may then automatically extinguish or otherwise update the co-signor's liability under the mortgage product, as shown at stage 320. As part of this stage, customer media generator 130 may send a communication to the co-signor and/or the borrower notifying that the co-signor's liability has been updated. If the co-signor's liability has been extinguished, then the borrower may then remain solely liable for the loan amount under the mortgage product.

If, however, mortgage processor 120 determines that the P/V factor is not above the first threshold value, then processing may proceed to stage 330, where processor 120 determines if the P/V factor is above a second threshold value. In this exemplary embodiment, the second threshold value reflects an owed amount of principal above that corresponding to the first threshold value. If the P/V factor has reached the second threshold value, then processor 120 may determine that the borrower and/or the co-signor should be notified that the co-signor's liability may be updated if certain requirements are met. In other words, if the P/V factor does not indicate a situation that may warrant automatic extinguishment of the co-signor's liability at stage 310 (i.e., “No” at stage 310), then system 100 may still allow extinguishment at higher amounts of owed principal if certain criteria have been met. For example, if the first threshold value corresponds to the situation where the amount of principal owed is 60% of a market value of the property, the second threshold value may correspond to a situation where the amount of principal owed is 80% of the market value of the property.

If the P/V factor has not reached the second threshold (i.e., “No” at stage 330), then processing may return to stage 310 until the first or second threshold values have been reached. If, however, the P/V factor has reached the second threshold value (i.e., “Yes” at stage 330), then processing proceeds to stage 340. At stage 340, customer media generator 130 may send a notification to the borrower or the co-signor of the requirements (e.g., as determined by processor 120 based on requirements and conditions for the same that may be stored in database 110) for extinguishing or otherwise updating the co-signor's liability. Such requirements may include, for example, requiring a current appraisal of the property indicating that the market value is above a certain identified amount. In other words, since the P/V factor may be based on a less accurate market value of the property, system 100 may require a current market value that may more accurately indicate the property's market value.

The required appraised market value may, for example, correspond to a P/V factor corresponding to the first threshold value. Alternatively, the required appraised market value may correspond to a P/V factor between the first and second threshold values, or may correspond to a confirmation that the appraised market value of the property is equal to at least the market value used by processor 120 to determine the P/V factor that meets or exceeds the second threshold value.

It should be noted, however, that the above described requirements are exemplary and that other types of requirements may be implemented by embodiments of the present invention. For instance, alternative embodiments may include updating the co-signor's liability based on the borrower's credit worthiness (e.g. the o-signor's liability is updated when the borrower's credit worthiness is proven by a certain amount).

Further, the notification sent by customer media generator 130 may identify other criteria for showing that the market value is above a certain identified amount. For instance, instead of an appraisal, the notification may require establishing the current market value based on, for example, governmental assessed property values.

Once media generator 130 has notified the borrower or co-signor, processing proceeds to stage 350 where processor 120 may determine whether the requirements have been met. If the borrower or co-signor has met these requirements, then processing may proceed to stage 320, where processor 120 updates the co-signor's liability. In the exemplary embodiment, processor 120 may extinguish the co-signor's liability. As described above, if processor 120 extinguishes the co-signor's liability, the borrower may remain solely liable for the loan amount under the mortgage product.

Accordingly, systems and methods consistent with embodiments of the invention provide financial loan arrangements to a borrower using a co-signor. While certain features and embodiments of the invention have been described, other embodiments of the invention will be apparent to those skilled in the art from consideration of the specification and practice of the embodiments of the invention disclosed herein. Furthermore, although embodiments of the present invention have been described as being associated with data stored in memory and other storage mediums, one skilled in the art will appreciate that these aspects can also be stored on or read from other types of computer-readable media, such as secondary storage devices, like hard disks, floppy disks, or a CD-ROM, a carrier wave from the Internet, or other forms of RAM or ROM. Further, the steps of the disclosed methods may be modified in any manner, including by reordering steps and/or inserting or deleting steps, without departing from the principles of the invention.

It is intended, therefore, that the specification and examples be considered as exemplary only, with a true scope and spirit of embodiments of the invention being indicated by the following claims and their full scope of equivalents. Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

1. A method, performed by a processor, for managing a financial loan product, wherein the financial loan product is for a principal monetary amount and is associated with a borrower, a co-signor, and an item of property, and wherein the co-signor has a liability associated with the financial loan product, the method comprising:
receiving payment data concerning payments made towards the principal amount;
monitoring a principal-to-value factor reflecting a currently owed amount of principal based on the received payment data and a market value of the item of property; and
determining, based on the monitored principal-to-value factor, whether to update the liability of the co-signor.

2. The method of claim 1, wherein the borrower is a buyer of the item of property and the financial loan product is to finance a purchase of the property.

3. The method of claim 1, wherein the borrower is an owner of the item of property and the financial loan product is for a refinancing arrangement for the property.

4. The method of claim 1, wherein the payment data includes a payment toward the principal monetary amount loaned to the borrower and a payment for any interest owed on the principal monetary amount.

5. The method of claim 1, wherein the principal-to-value factor reflects the currently owed amount of principal as compared to a market value associated with the property.

6. The method of claim 5, wherein the principal-to-value factor indicates the percentage of the item of property's market value that corresponds to the currently owed amount of principal.

7. The method of claim 1, wherein monitoring the principal-to-value factor further includes:
determining a current market value of the item of property; and
determining the principal-to-value factor based on the determined market value of the item of property.

8. The method of claim 7, wherein determining the current market value of the item of property further includes:
obtaining an appraised value of the item of property.

9. The method of claim 7, wherein determining the current market value of the item of property further includes:
determining the current market value of the item of property based on property tax records for the item of property.

10. The method of claim 1, wherein monitoring the principal-to-value factor further includes:
determining whether the principal-to-value reaches a first predetermined threshold value; and
notifying, if the principal-to-value reaches the first predetermined threshold value, at least one of the borrower and the co-signor of requirement criteria for updating the liability of the co-signor.

11. The method of claim 10, wherein the requirement criteria requires proof that the item of property has at least a certain market value.

12. The method of claim 11, wherein the required proof is an appraisal of the item of property's value.

13. The method of claim 10, wherein determining whether to update the liability of the co-signor further includes:
updating the liability of the co-signor if the requirement criteria has been met.

14. The method of claim 10, wherein the first predetermined threshold value is based on a principal monetary loan amount above a loan amount for which the borrower would not require a co-signor for the financial loan product.

15. The method of claim 1, wherein determining whether to update the liability of the co-signor further includes:
comparing the principal-to-value factor with a first predetermined threshold value; and
determining to update the liability of the co-signor when the principal-to-value factor reaches the first predetermined threshold value.

16. The method of claim 15, wherein the first predetermined threshold value is based on a principal monetary loan amount for which the borrower would not require a co-signor for the financial loan product.

17. The method of claim 1, wherein determining whether to update further includes:
notifying at least one of the borrower and the co-signor of requirement criteria for updating the liability of the co-signor.

18. The method of claim 17, wherein the requirements for updating the liability of the co-signor includes requiring an appraisal of the item of property.

19. The method of claim 18, wherein the liability of the co-signor is updated if an appraised value of the item of property is above a predetermined threshold value based on the currently owed amount of principal.

20. The method of claim 19, wherein the liability of the co-signor is extinguished if the appraised value is above the predetermined threshold value.

21. The method of claim 1, wherein determining whether to update further includes:
determining whether to extinguish the liability of the co-signor based on the monitored principal-to-value factor.

22. The method of claim 1, wherein the item of property is real property.

23. The method of claim 1, wherein the item of property is personal property.

24. A system for managing a financial loan product, wherein the financial loan product is for a principal monetary amount and is associated with a borrower, a co-signor, and an item of property, and wherein the co-signor has a liability associated with the financial loan product, the system comprising:
a component for receiving payment data concerning payments made towards the principal amount;
a component for monitoring a principal-to-value factor reflecting a currently owed amount of principal based on the received payment data and a market value of the item of property; and
a component for determining, based on the monitored principal-to-value factor, whether to update the liability of the co-signor.

25. The system of claim 24, wherein the borrower is a buyer of the item of property and the financial loan product is to finance a purchase of the item of property.

26. The system of claim 24, wherein the borrower is an owner of the item of property and the financial loan product is for a refinancing arrangement for the item of property.

27. The system of claim 24, wherein the payment data includes a payment toward the principal monetary amount loaned to the borrower and a payment for any interest owed on the principal monetary amount.

28. The system of claim 24, wherein the principal-to-value factor reflects the currently owed amount of principal as compared to a market value associated with the item of property.

29. The system of claim 28, wherein the principal-to-value factor indicates a percentage of the item of property's market value corresponding to the currently owed amount of principal.

30. The system of claim 24, wherein the component for monitoring the principal-to-value factor further includes:
a component for determining a current market value of the item of property; and
a component for determining the principal-to-value factor based on the determined market value of the item of property.

31. The system of claim 30, wherein the component for determining the current market value of the item of property further includes:
a component for obtaining an appraised value of the item of property.

32. The system of claim 30, wherein the component for determining the current market value of the item of property further includes:
a component for determining the current market value of the item of property based on property tax records for the item of property.

33. The system of claim 24, wherein the component for monitoring the principal-to-value factor further includes:
a component for determining if the principal-to-value reaches a first predetermined threshold value; and
a component for notifying, if the principal-to-value reaches the first predetermined threshold value, at least one of the borrower and the co-signor of requirement criteria for updating the liability of the co-signor.

34. The system of claim 33, wherein the requirement criteria requires proof that the item of property has at least a certain market value.

35. The system of claim 34, wherein the required proof is an appraisal of the item of property's value.

36. The system of claim 34, wherein the component for determining whether to update the liability of the co-signor further includes:
a component for updating the liability of the co-signor if the requirement criteria has been met.

37. The system of claim 34, wherein the first predetermined threshold value is based on a principal monetary loan amount above a loan amount for which the borrower would not require a co-signor for the financial loan product.

38. The system of claim 24, wherein the component for determining whether to update the liability of the co-signor further includes:
a component for comparing the principal-to-value factor with a first predetermined threshold value; and
a component for determining to update the liability of the co-signor when the principal-to-value factor reaches the first predetermined threshold value.

39. The system of claim 38, wherein the first predetermined threshold value is based on a principal monetary loan amount for which the borrower would not require a co-signor for the financial loan product.

40. The system of claim 24, wherein the component for determining whether to update further includes:
a component for notifying at least one of the borrower and the co-signor of requirement criteria for updating the liability of the co-signor.

41. The system of claim 40, wherein the requirements for updating the liability of the co-signor includes requiring an appraisal of the item of property.

42. The system of claim 41, wherein the liability of the co-signor is updated if an appraised value of the item of property is above a predetermined threshold value based on the currently owed amount of principal.

43. The system of claim 42, wherein the liability of the co-signor is extinguished if the appraised value is above the predetermined threshold value.

44. The system of claim 24, wherein the component for determining whether to update further includes:
a component for determining whether to extinguish the liability of the co-signor based on the monitored principal-to-value factor.

45. The system of claim 24, wherein the item of property is real property.

46. The method of claim 24, wherein the item of property is personal property.

47. A computer-readable medium which stores a set of instructions which when executed performs a method for managing a financial loan product, wherein the financial loan product is for a principal monetary amount and is associated with a borrower, a co-signor, and an item of property, and wherein the co-signor has a liability associated with the financial loan product, the method executed by the set of instructions comprising:
receiving payment data concerning payments made towards the principal amount;
monitoring a principal-to-value factor reflecting a currently owed amount of principal based on the received payment data and a market value of the item of property; and
determining, based on the monitored principal-to-value factor, whether to update the liability of the co-signor.

48. The computer-readable medium of claim 47, wherein the borrower is a buyer of the item of property and the financial loan product is to finance a purchase of the item of property.

49. The computer-readable medium of claim 47, wherein the borrower is an owner of the item of property and the financial loan product is for a refinancing arrangement for the item of property.

50. The computer-readable medium of claim 47, wherein the payment data includes a payment toward the principal monetary amount loaned to the borrower and a payment for any interest owed on the principal monetary amount.

51. The computer-readable medium of claim 47, wherein the principal-to-value factor reflects the currently owed amount of principal as compared to a market value associated with the item of property.

52. The computer-readable medium of claim 51, wherein the principal-to-value factor indicates the percentage of the item of property's market value that corresponds to the currently owed amount of principal.

53. The computer-readable medium of claim 47, wherein monitoring the principal-to-value factor further includes:
determining a current market value of the item of property; and
determining the principal-to-value factor based on the determined market value of the item of property.

54. The computer-readable medium of claim 53, wherein determining the current market value of the item of property further includes:
obtaining an appraised value of the item of property.

55. The computer-readable medium of claim 53, wherein determining the current market value of the item of property further includes:
determining the current market value of the item of property based on property tax records for the item of property.

56. The computer-readable medium of claim 47, wherein monitoring the principal-to-value factor further includes:
determining whether the principal-to-value reaches a first predetermined threshold value; and
notifying, if the principal-to-value reaches the first predetermined threshold value, at least one of the borrower and the co-signor of requirement criteria for updating the liability of the co-signor.

57. The computer-readable medium of claim 56, wherein the requirement criteria requires proof that the item of property has at least a certain market value.

58. The computer-readable medium of claim 57, wherein the required proof is an appraisal of the item of property's value.

59. The computer-readable medium of claim 56, wherein determining whether to update the liability of the co-signor further includes:
updating the liability of the co-signor if the requirement criteria has been met.

60. The computer-readable medium of claim 56, wherein the first predetermined threshold value is based on a principal monetary loan amount above a loan amount for which the borrower would not require a co-signor for the financial loan product.

61. The computer-readable medium of claim 47, wherein determining whether to update the liability of the co-signor further includes:
comparing the principal-to-value factor with a first predetermined threshold value; and
determining to update the liability of the co-signor when the principal-to-value factor reaches the first predetermined threshold value.

62. The computer-readable medium of claim 61, wherein the first predetermined threshold value is based on a principal monetary loan amount for which the borrower would not require a co-signor for the financial loan product.

63. The computer-readable medium of claim 47, wherein determining whether to update further includes:
notifying at least one of the borrower and the co-signor of requirement criteria for updating the liability of the co-signor.

64. The computer-readable medium of claim 63, wherein the requirements for updating the liability of the co-signor includes requiring an appraisal of the item of property.

65. The computer-readable medium of claim 64, wherein the liability of the co-signor is updated if an appraised value of the item of property is above a predetermined threshold value based on the currently owed amount of principal.

66. The computer-readable medium of claim 65, wherein the liability of the co-signor is extinguished if the appraised value is above the predetermined threshold value.

67. The computer-readable medium of claim 47, wherein determining whether to update further includes:
determining whether to extinguish the liability of the co-signor based on the monitored principal-to-value factor.

68. The computer-readable medium of claim 47, wherein the item of property is real property.

69. The computer-readable medium of claim 47, wherein the item of property is personal property.
